(19) United States
(12) Patent Application Publication
(10) Pub. No.: US 2026/0238383 A1
(43) Pub. Date: Aug. 13, 2026

(54) APPARATUS AND METHOD FOR GENERATING SYMBOLS USING A NEURAL NETWORK BASED SYMBOL GENERATOR IN A WIRELESS COMMUNICATIONS SYSTEM

(71) Applicant: Lenovo (United States) Inc., Morrisville, NC (US)

(72) Inventors: Vahid Pourahmadi, München (DE); Vijay Nangia, Woodridge, IL (US)

(21) Appl. No.: 19/052,169

(22) Filed: Feb. 12, 2025

(51) Int. Cl. H04L 1/00; H04W 28/04

(52) U.S. Cl. CPC H04L 1/007; H04W 28/04

(57) ABSTRACT

Various aspects of the present disclosure relate to methods, apparatuses, and devices for wireless communication. A first node may be configured to, capable of, or operable to receive input bits of a codeword or encode information bits corresponding to a transport block with a forward error correction code to generate the input bits. A quantity of the input bits is a multiple of a characteristic parameter of a neural network-based symbol generator. The first node may be configured to, capable of, or operable to generate symbols based on the input bits and the neural network-based symbol generator. A first symbol of the symbols is based on a first subset of the input bits, the first subset includes a first quantity of bits larger than the characteristic parameter of the neural network-based symbol generator. A second symbol of the symbols is based on a second subset of the input bits.

### TECHNICAL FIELD

The present disclosure relates to wireless communications, and more specifically to generating symbols using a neural network based symbol generator in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved nodes, network entities, processors, and methods for indicating a custom operation to group members in a wireless communications system.

A first node for wireless communication is described. The first node may be configured to, capable of, or operable to receive a plurality of input bits of a codeword or encode a plurality of information bits corresponding to a transport block with a forward error correction code to generate the plurality of input bits of the codeword, wherein a quantity of the plurality of input bits is a multiple of a characteristic parameter of a neural network-based symbol generator. The first network entity may be configured to, capable of, or operable to generate a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same. The first network entity may be configured to, capable of, or operable to transmit, to a second node, a mapping of the plurality of symbols based on a transmission scheme.

A processor for wireless communication is described. The processor may be configured to, capable of, or operable to receive a plurality of input bits of a codeword or encode a plurality of information bits corresponding to a transport block with a forward error correction code to generate the plurality of input bits of the codeword, wherein a quantity of the plurality of input bits is a multiple of a characteristic parameter of a neural network-based symbol generator. The processor may be configured to, capable of, or operable to generate a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same. The processor may be configured to, capable of, or operable to transmit, to a second node, a mapping of the plurality of symbols based on a transmission scheme.

A method performed or performable by a first node for wireless communication is described. The method may include receiving a plurality of input bits of a codeword or encoding a plurality of information bits corresponding to a transport block with a forward error correction code to generate the plurality of input bits of the codeword, wherein a quantity of the plurality of input bits is a multiple of a characteristic parameter of a neural network-based symbol generator. The method may include generating a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same. The method may include transmitting, to a second node, a mapping of the plurality of symbols based on a transmission scheme.

A second node for wireless communication is described. The second node may be configured to, capable of, or operable to receive a plurality of symbols associated with a plurality of time-frequency resources for a plurality of receiving antennas. The second node may also be configured to, capable of, or operable to select a subset of the plurality of symbols for each antenna of the plurality of receiving antennas and generating a plurality of input streams for the plurality of receiving antennas based on the selected subset of the plurality of symbols. The second node may be configured to, capable of, or operable to generate a plurality of output-data estimations based on the plurality of input streams and a neural network-based bit-estimation-generator.

### BRIEF DESCRIPTION OF THE DRAWINGS

FIG. 1 illustrates an example of a wireless communications system in accordance with aspects of the present disclosure.

FIG. 2 illustrates an example of a block diagram of blocks that may be in a transmitter in accordance with aspects of the present disclosure.

FIG. 3 illustrates an example of a symbol generator (SG) neural network (NN)-block in accordance with aspects of the present disclosure.

FIG. 4 illustrates another example of a block diagram of blocks that may be in a receiver in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method performed by a first node in accordance with aspects of the present disclosure.

FIG. 9 illustrates a flowchart of another method performed by a second node in accordance with aspects of the present disclosure.

### DETAILED DESCRIPTION

Some wireless communication systems, including one or more UEs, base stations, network entities, nodes, or the like may support generating symbols using a NN-based symbol generator. In some cases, operations associated with symbol generation may be inefficient, such as using increased signaling overhead and power consumption. By way of example, some wireless communication systems may generate symbols without the use of NN-based symbol generation, resulting in higher use of resources (e.g., system bandwidth) and increased power consumption.

Various aspects of the present disclosure relate to enabling one or more UEs, base stations, network entities, nodes, or the like to support improvements to encoding information bits. In some examples, one or more UEs, base stations, network entities, nodes, or the like may be configured to encode a plurality of information bits corresponding to a transport block with a forward error correction code to generate the plurality of input bits of the codeword. Additionally, or alternatively, one or more UEs, base stations, network entities, nodes, or the like may be configured to generate a plurality of symbols based on the plurality of input bits and the neural network-based symbol generator. By using such operations, one or more UEs, base stations, network entities, nodes, or the like may experience reduced power consumption, decreased processor usage, reduce data usage, and increase overall system performance.

Aspects of the present disclosure are described in the context of a wireless communications system.

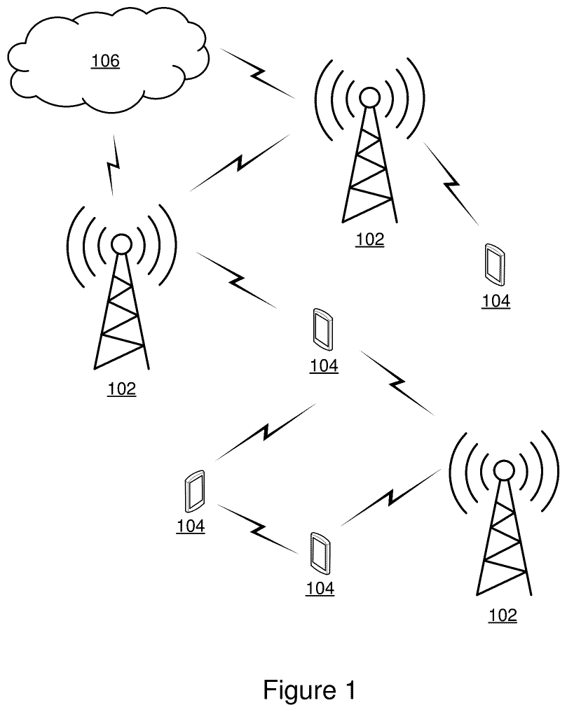

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In certain 5G NR systems, wireless communications devices may utilize a physical layer for the transmission and reception of data over an air interface. This may involve several key processes including modulation, channel coding, and multiplexing.

Modulation may be a critical function in the physical layer, where the physical layer converts data bits into a form suitable for transmission over the radio frequency (RF) medium. Some modulation schemes used in 5G NR include quadrature amplitude modulation (QAM) and quadrature phase shift keying (QPSK). These schemes may be chosen for their ability to efficiently use the available spectrum and maintain robustness against various types of interference and signal degradation.

For example, 64-QAM may be a modulation scheme used in 5G NR, where each symbol represents six bits of data. This may allow for a higher data rate compared to simpler schemes like QPSK, which only represents two bits per symbol. However, higher-order modulation schemes like 64-QAM may be more susceptible to noise and interference, requiring better signal quality to maintain performance.

Certain modulation processes in 5G NR may include the following steps: bit mapping—input data bits are mapped to modulation symbols according to a chosen modulation scheme (e.g., QPSK, 16-QAM, 64-QAM); and symbol generation—the mapped bits are converted into complex symbols representing points in a constellation diagram. These symbols may then be mapped to certain resource elements (REs) as certain subcarrier/orthogonal frequency division multiplexing (OFDM) symbol which are then used to create the time-domain signal for transmission based OFDM.

Despite the efficiency and robustness of certain modulation schemes and symbol mapping, there may be a growing interest in exploring advanced techniques such as neural networks (NN).

As depicted in the drawings, there is a procedure for transmitting input bits which generalizes the notion of modulating and RE mapping and offers an alternative way for modulation and changes the way that bits (symbols) are assigned to specific subcarriers/OFDM symbols. This may lead to improved spectral efficiency, reduced error rates, and better overall performance.

5G NR may represent the latest advancement in wireless communication standards, designed to support a wide range of applications with varying requirements for data rate, latency, and reliability. Central to 5G NR may be its flexible and robust physical layer, which leverages OFDM for efficient data transmission.

OFDM is a spectral-efficient modulation technique that divides the available bandwidth into multiple orthogonal subcarriers, allowing simultaneous transmission of data streams. In 5G NR, the OFDM-based physical layer may ensure high data rates and resilience against multipath fading and interference.

An OFDM signal may be generated by mapping data symbols onto REs, which are the smallest units of resource allocation in the frequency-time grid. An RE consists of one subcarrier in frequency and one OFDM symbol in time. Groups of REs form Resource Blocks (RBs), which are the fundamental units of resource allocation for scheduling data in the network. As one example, an RB in 5G NR comprises 12 consecutive subcarriers in the frequency domain and a specific number of OFDM symbols in the time domain (e.g., 14 OFDM symbols), depending on the numerology used (e.g., subcarrier spacing of 15 kHz, 30 kHz, etc.). RBs provide a standardized way to allocate and manage frequency-time resources, enabling scalable and flexible communication.

$$RB = \{ {f}_{k} , {t}_{s} \} for k = 1 , … , K and s = 1 , … , S$$

where fₖ denotes the kth subcarrier and tₛ denotes the sth OFDM symbol within the RB.

Some of the REs in the RB may be used for pilot or reference signal transmission (for one or a plurality of receiving nodes (e.g., UEs)). In some examples, some of the REs in the RB may be zero-power REs or may be used for control signalling. In the following, there may not be a limit to the RB size of 5G NR and it may not be a size that fits application requirements.

To enhance data throughput and reliability, 5G NR may employ multiple input multiple output (MIMO) technology, using multiple antennas at both the transmitter (Tx) and receiver (Rx). In this context, the transmitter is equipped with M antennas, and the receiver has N antennas.

MIMO may also enable spatial multiplexing, allowing the transmission of multiple data streams (layers) simultaneously (e.g., to one receiving node or a plurality of receiving nodes). Each layer may be independently modulated and transmitted across different spatial channels.

The generation of an OFDM symbol may involve several key steps. First, there may be modulation in which data bits are first encoded using forward error correction (FEC) codes to enhance reliability and may be interleaved using an interleaver. The encoded bits may then be mapped to complex symbols (e.g., QAM or PSK) using a modulation scheme. In some examples, the data bits correspond to a transport block. The encoded/channel coded bits may also correspond to a codeword, and the codeword may be mapped to one or more layers. For example, let d_{l,b}[j, s] where j={1, 2, . . . , J} represents the j-th complex symbol for the l-th layer, l={1, 2, . . . , L}, within RB b at OFDM symbol time s. Note that J could be at most equal to K (the number of subcarriers in one RB). In practice they are sometimes less than K, as some of the subcarriers are used for transmission of other signals like control messages or pilot signals.

Second, there may be layer-to-antenna mapping (e.g., spatial multiplexing). Before performing an inverse fast Fourier transform (IFFT) and cyclic prefix (CP) addition, multiple data layers may be spatially multiplexed across available transmit antennas. This mapping can be achieved through various MIMO techniques, such as: spatial multiplexing (open-loop)-in one example for open-loop spatial multiplexing, each antenna transmits a distinct layer, enabling parallel transmission of multiple data streams; and beamforming/precoding-layers are pre-coded and combined with precoding weight matrices to steer the signal towards specific spatial directions, optimizing signal quality at the receiver.

Mathematically, the mapping of L layers to M transmit antennas can be represented by a precoding matrix Pₗ∈C^{M×1}: X_{l,b}[s]=Pₗ·D_{l,b}[s]

Where D_{l,b}[s]∈C^{1×J} is the matrix/vector with/elements representing the data symbols (d_{l,b}[j, s]) of layer l for RB b and OFDM symbol s. X_{l,b}[s]∈C^{M×J} is the resulting matrix after precoding, to be transmitted from M antennas for layer l for RB b. X_{l,b}[s] l={1, 2, . . . , L} are combined

$$( {X}_{b} [ s ] = {\sum }_{l = 1}^{L} {X}_{l , b} [ s ] )$$

resulting in the matrix X_{b}[s]∈C^{M×J} to be mapped on to the REs for RB b for transmission from the M antennas.

In some cases, D_{l,b}[s] may be modified before precoding, where some symbols may be added/modified inside of the D_{l,b}[s]. For example, sometimes pilot symbols are added on some element of the vector. So, the length of the vector might be different than J, e.g., j′, in this more general case, X_{l,b}[s] will be form C^{M×J′}

Third, there may be RE mapping where the complex symbols, X_{b}[s], are mapped onto REs within RBs according to the scheduling assignments. Each RE corresponds to a specific subcarrier and OFDM symbol. The RE mapper may map its respective pre-coded symbols onto dedicated REs of each antenna within the allocated RBs. This may ensure that each antenna transmits its unique set of symbols.

The mapper may determine which element of X_{l,b}[s] (or generally X_{b}[s]) of size M×J or M×J′ should be assigned to which subcarrier of OFDM symbol s of each of the M antennas. As there may be multiple layers, the final symbol of a particular RE may be the combination of all symbols from each layer that are all mapped to the particular RE.

On one or a few of antennas, some REs may be left black or filled with some symbols not coming from any of X_{l,b}[s]. For example, these symbols might act as pilot symbols or carry some control information. The final matrix of Λ[s]∈C^{M×K} may represent the signals that should be transmitted on each of the K subcarriers of the s-th OFDM symbol.

Fourth, there may be generation of time-domain signals and CP addition by applying IFFT to convert frequency-domain symbols of Λ[s] to time-domain samples:

$$R [ s ] = IFFT ( Λ [ s ] ) .$$

In practical systems and to combat a multi-path effect, it may be possible to add CP to a resulted signal before transmission.

Fifth, there may be transmission over MIMO channels where the wireless channel between each transmit antenna m and receive antenna r is characterized by a channel matrix H_{m,r}(k, s) for different subcarrier k and different OFDM symbol s based on the channel statistics.

Sixth, there may be processing at the receiver in which the receiver performs a series of operations to recover the transmitted data. CP removal, FFT operation, channel estimation, and equalization. The results may be a set of symbols transmitted over RB b, corresponding to D_{l,b}[s], \hat{D}_{l,b}[s] for each of the layers.

Seventh, the data bits may be retrieved. The last steps to recover the data bits may be to demodulate the \hat{D}_{l,b}[s] to recover the original bits from symbols, perform deinterleaving, and FEC decoding as needed.

In some neural network (NN)-based implementations, an NN block is used for converting the input bits to modulation points. More precisely, in place of symbol generated by a conventional modulator, the NN block receives Q bits from an input stream and generates a complex value (or two real values repressuring the real and imaginary part of the complex number) from a set of 2^{Q} complex numbers.

During the training process, the NN-based modulator gradually learns the best set of 2^{Q} complex numbers. The correct selection of these complex numbers improves the possibility of correct detection of the transmitted symbol at the receiver.

One important limitation of the conventional schemes and the described NN-based modulator scheme is that in these methods, each of the Q input data bits are affecting only the symbol on one of the REs, and then the whole J×Q bits are mapped to J symbols (but each carry information about only Q data bits). So, if that RE cannot be well detected due to some effect as noise, nonlinearity, or fading, the information of those Q bits may be lost.

Additionally, as the modulation scheme is similar for all REs, it may not be possible to send more bits (from the input data) on some REs and less bit on some other REs. Having such a property may help to pack more bits in some REs and so some REs may remain empty or may be used for sending information that can be used for improving the detection at the receiver.

Consider a communication link with a Tx equipped with M antennas, and a Rx has N antennas, respectively. It may be an aim to send a series of bits and use OFDM for data transmission.

The OFDM signal may be generated using frequency-domain symbols matrix Λ[s]∈C^{M×\hat{K}} for s={1, 2, . . . , Ŝ} where s represent the OFDM symbol and \hat{K} is number subcarrier in the bandwidth. C shows the domain of complex numbers. The total time and bandwidth are petitioned to a smaller unit called RB where each RB is composed of S OFDM symbol (S≤Ŝ) and K subcarriers (K≤ [symbol] . RE is then defined as a single OFDM symbol and subcarrier which can carry a symbol. The number of REs in one RB is then equal to K×S. Considering that we have M antennas and each antenna will carry K×S symbols, the total number of symbols should be decided M×K×S.

Considering all the RBs, the Tx, in total, may decide for M×K′×S′ symbols (K′≤K, S′≤S) for generation of the OFDM signal. Let the symbols of one RB be denoted by Γ∈C^{M×K×S} and Γ(m, k, s) or

$${Γ}_{m , b}^{s} [ k ]$$

represents the symbol, i.e., a complex number, related to the k-th subcarrier of the s-th OFDM symbol of the m-th antenna for RB b. In certain methods, some of the Γ(m, k, s) may be filled with some symbols related to pilots, control information, or may be kept empty. All other entries may be filled with symbols based on the input data bits (e.g., output of channel coding (FEC) representing encoded/channel coded bits) to be transmitted.

For simplicity of notation, for each antenna, and for one RB, from the total of K×S entries, J′ REs are available for data transmission so Γ can be represented by J′ vector γ_{b}[i]∈C^{M} for RB b where i={1, 2, . . . , J′}, where γ_{b}[i] represents the M complex number (for each of the M antennas) associated to the i-th RE of the b-th Rb. Here it is assumed that the available REs are the same in all antennas, but if one antenna, e.g., m₁, has a preset value (not generated from the input data) for a particular RE, e.g., i₁, that value can be set on the corresponding element of γ_{b}, e.g., γ_{b}[i₁][m₁]=preset value.

In conventional communication, the b-th RB, γ_{b}[i] s depend on their corresponding complex values generated from each stream l for that RB, λ_{l,b}[i]∈C^{M} where i={1, 2, . . . , J′}, for example,

$${γ}_{b} [ i ] = {\sum }_{l = 1}^{L} {λ}_{l , b} [ i ] . {λ}_{l , b} [ i ]$$

itself is the result of precoding step that maps the symbols ζ_{l,b}[i]∈C¹ where i={1, 2, . . . , J′} associated with each stream l. Each of the ζ_{l,b}[i] is a complex number. A few elements of ζ_{l,b}[i] for i={1, 2, . . . , J′} may be selected based on data other than the data bits, for example, for transmission of pilots or empty/zero-power elements. The remaining symbols, e.g. J out of J′ where j≤J′, are generated based on the data bits of the stream l. It is assumed that symbols i={1, 2, . . . , J} of ζ_{l,b}[i] are the ones that are generated based on the input data bits. Note that in practice, these symbols do not need to be the first/symbols but could be other J symbols of the total J′ symbols of ζ_{l,b}.

Consider that a modulator uses a modulator of order Q meaning that it has 2^{Q} constellation points. With this modulator, for the generation of ζ_{l,b}[i] for i={1, 2, . . . , J}, the transmitter gets input data bit stream of length Q×J, i.e., d_{l,b}[ν] where ν={1, 2, . . . , Q×J}. It then divides the Q×J data bits of each stream (layer) into/groups each with Q data bits and each group is then mapped to a consolation point (a complex number) based on the design of the modulator.

It should be noted that the input data bits may be an encoded version of the actual input data bits based on a FEC code like LDPC code. For simplify, here, the encoded/channel coded data bits may be referred to as the input data bits. In certain processes, for each stream (layer), the transmitter effectively tries to convert each Q of the input data bits into one symbol (one complex number) and this complex number is used to construct one symbol for a certain RE of one OFDM RB (e.g., based on the symbols/complex numbers of all the streams). For example, the transmitter may map this complex number to each transmit antennas using a precoder and then combine the effect of all layers to construct the symbol of each RE.

There may be two important properties of certain schemes. An important effect here may be that each of the Q input data bits affect only the symbol on one of the REs, and then the whole J×Q bits are mapped to/symbols (but each carry information about only Q data bits).

As there are/REs and J symbols, all REs may be used for transmission of the J×Q data bits and there may not be any RE for sending extra information (e.g., other than the input data bits).

To improve the performance of the communication link, the following procedures for generation of the symbols may be associated with the input data bits. The following properties may be part of such procedures.

Instead of having each symbol ζ_{l,b}[i] be dependent on only one set of Q input data bits, each symbol ζ_{l,b}[i] for i={1, 2, . . . , J} may be based on all or a subset (more than one set of Q input data bits) of d_{l,b}[ν] where ν={1, 2, . . . , Q×J}. This design may help the performance of the system as, for example, if an RE falls into a deep fade its content might be able to be extracted from other REs (e.g., even without channel coding or with minimal (e.g., high code-rate) channel coding).

As there may be no notion of fixed Q data bits per symbol (consolation point), the transmitter may decide to combine more than Q data bits into a single complex number for some ν's and, in some cases, may combine less than Q data bits for generation of symbols associated with another RE. The transmitter may also decide not to use input data bits for setting up the symbol (complex number) associated with some of the REs or instead may send some complex numbers that may help in recovery of at least one input data bit at the receiver. For example, sending some symbols that can help to achieve better channel estimation.

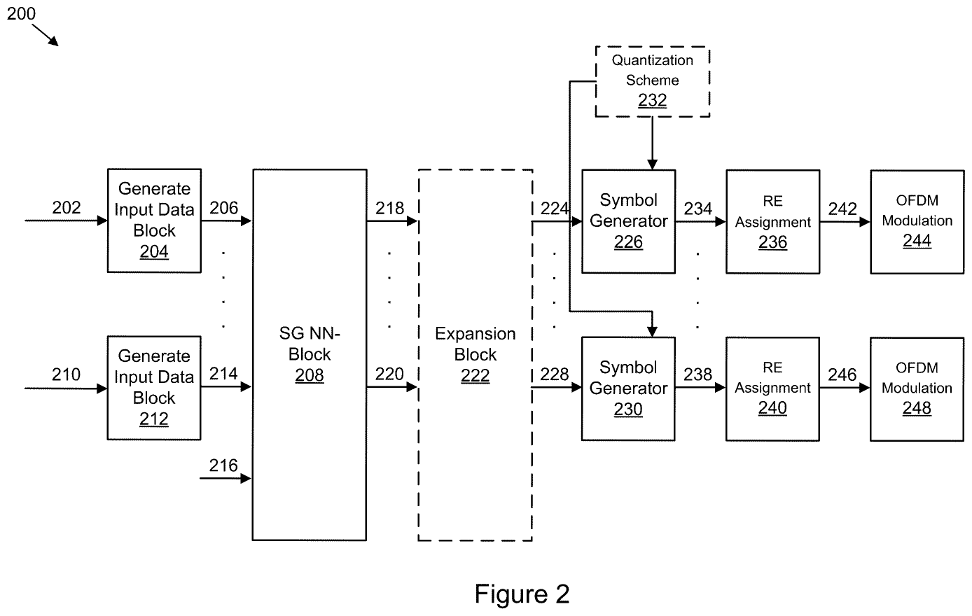

FIG. 2 illustrates an example of a block diagram 200 of blocks that may be in a transmitter in accordance with aspects of the present disclosure. A NN block may be used for generation of the symbols as shown in FIG. 2. In FIG. 2, the input stream associated with a layer (stream) l 202, 210 is first partitioned using generate input data blocks 204, 212 into blocks of bits, d_{l,b}[ν] 206, 214, that are to be transmitted over one RB. It may be assumed that each RB may transmit J symbols based on the input data. Therefore, assuming that on average there may be Q bits per symbol transmitted, d_{l,b}[ν] will have Q×J bits, i.e., ν={1, 2, . . . , Q×J}.

d_{l,b}[ν] 106, 214 for all layers, l={1, . . . , L} are then fed as the input of a symbol generator (SG) NN-block 208, which has been trained to generate r_{b}[ν] where ν={1, . . . , L′×J×2} real valued numbers. r_{b}[ν] can be further partitioned into L′ output stream each with length J×2, denoted by r_{l,b}[ν] 218, 220 where l={1, . . . , L′} and ν={1, . . . , J×2}.

In some implementations, input to the SG NN-block 208 may include parameters 216 other than d_{l,b}[ν], for example, the current SNR of the link, the suggested (e.g., CSI feedback (e.g., CQI, PMI, RI) associated with the receiver) precoding vectors, or another feedback data received from the receiver or another device.

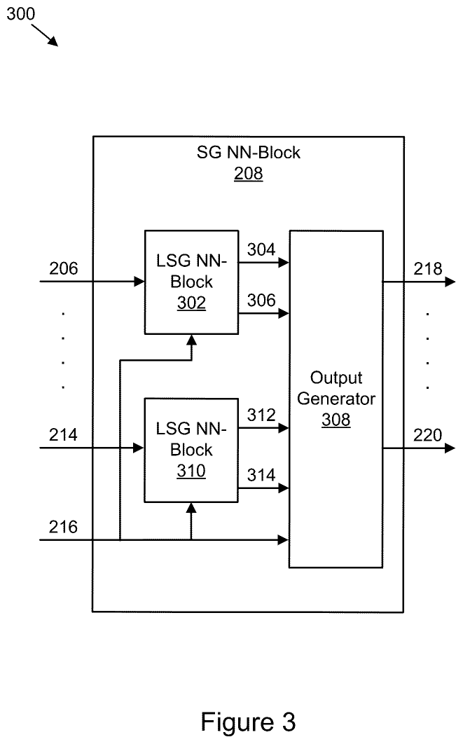

FIG. 3 illustrates an example of the SG NN-block 208 in accordance with aspects of the present disclosure. In one implementation, the SG NN-block 208 itself includes L neural network models with a similar structure, called layer-symbol-generator (LSG) NN-block 302, 310. Each of the LSG blocks 302, 310 receives 1 of the L input streams as the input 206, 214 and generates L″ output streams 304, 306, 312, 314,

$${r}_{l , b}^{p} [ v ]$$

where l={1, . . . , L″} and p represent the id of the input stream. The output of all LSG NN-blocks 302, 310 then can be used to generate the L′ output streams 218, 220 needed as the output of the SG block-using an output generator 308. For example, in one implementation L″ could be equal to L′. In this case, the output streams may be generated as the sum or average of the output of all L LSG blocks. In another example, L″ may be equal to 1 and L′ may be equal to L. In this case, the SG output stream may be generated based on concatenation or stacking of the output of the L LSG blocks.

In one implementation, L′ may be equal to a number of Tx antennas, M. In this case, r_{l,b}[ν] for l={1, . . . , M} are in fact what will be assigned to/transmitted from each antenna and may be referred to as Tx-stream,

$${r}_{l , b}^{Tx} [ v ] .$$

In another implementation, L′ may be equal to L, meaning that the SG NN-block 208 generates the same number of steams as the input streams (layers). In a further implementation, L′ may be less than M. In this case, returning to FIG. 2, an expansion block 222 may be applied to generate M streams for each antenna, i.e., Tx-stream,

$${r}_{l , b}^{Tx} [ v ]$$

from the L′ output stream. The expansion block 222 may be itself based on a NN model or may use some legacy schemes to map from the output streams (associated with input layer) to M Tx-streams. Moreover, the expansion block 222 may provide outputs 224, 228 to symbol generators 226, 230. In some configurations, a quantization scheme 232 (e.g., vector quantizer) may provide outputs to the symbol generators 226, 230. Further, the symbol generators 226, 230 provide outputs 234, 238 to RE assignment 236, 240 devices. In addition, the RE assignment 236, 240 devices provide outputs 242, 246 to OFDM modulation 244, 248 devices.

One example for an NN-block may be to have M trainable variables for each output stream, aₗ∈C^{M} l={1, . . . , L′} that are multiplied with the corresponding r_{l,b}[ν] for ν={1, . . . , J×2} and generate L′ set of matrixes each have M rows and each row we have J×2 elements. Summing all the L′ matrixes, there may be M Tx-streams each of size J×2 elements,

$${r}_{l , b}^{Tx} [ v ] .$$

Certain precoders like orthogonal precoders or DFT precoders may also be used for generation of M Tx-streams from L′ output stream. Having

$${r}_{l , b}^{Tx} [ v ] ,$$

each of the ν={1, . . . , J×2} and each l={1, . . . , M} of

$${r}_{l , b}^{Tx} [ v ] ,$$

based on a pre-defined order, may be mapped to the/REs available for data transmission at b-th RB of the l-th antenna. The symbol (complex-number) generated for each RE, e.g., j-th RE of the b-th RB of the l-th antenna, Γ_{l,b}[j], is constructed as a complex number where the real and imaginary parts are based on two of the real-values of generated

$${r}_{l , b}^{Tx} [ v ] v = \{ J \times 2 \} .$$

In some implementation, before construction of the Γ_{l,b}[j],

$${r}_{l , b}^{Tx} [ v ]$$

are quantized using a quantizer scheme, for example, a vector or scalar quantizer. In one implementing, complex values, i.e., Γ_{l,b}[j], are generated based on

$${r}_{l , b}^{Tx} [ 2 j - 1 ] + 1 \text{?} \times {r}_{l , b}^{Tx} [ 2 j ]$$

$$\text{?} \text{indicates text missing or illegible when filed}$$

or for example

$${r}_{l , b}^{Tx} [ j ] + 1 \text{?} \times {r}_{l , b}^{Tx} [ j + J ] .$$

$$\text{?} \text{indicates text missing or illegible when filed}$$

The selection of the construction method may be based on the implementation, but any method may be such that each element of

$${r}_{l , b}^{Tx} [ v ]$$

for ν={1, . . . , J×2} is mapped exactly in one of the real or imaginary parts of one the Γ_{l,b}[j]. It should be noted that the selection of the/REs of the total K×S REs in each RB is based on the implementation and also the order of which of the J generated Γ_{l,b}[j] for ν={1, . . . , J} is assigned to which of the selected/REs is based on the implementation.

In some implementations, a method is used to generate a complex number and then the quantization scheme 232 may be used to quantize the resulted complex number by mapping each of them to one of the [symbol] possible complex numbers. The quantized version is considered as the final Γ_{l,b}[j]. In certain implementation, the [symbol] possible complex numbers may be trained during the design of the NN-blocks.

In various implementations, a method is used to map J×2 values of

$${r}_{l , b}^{Tx} [ v ] ,$$

into J vectors of each length 2. Then, a vector quantizer scheme is used to quantize these vectors of size 2. In some implementations, the vector quantizer has [symbol] codewords each with length 2. Then for each of the/vectors, the quantizer selects the closest codeword among these [symbol] codewords. The final complex valued Γ_{l,b}[j] is then generated using the/resulted quantized versions. In certain implementations, the [symbol] possible codewords may be trained during the design of the NN-blocks.

The transmitter uses may use generated Γ_{l,b}[j] plus potentially some other symbols, for example for pilot transmission, and, in some configurations, the subcarrier used for guard bands and required CP length for generation of the final OFDM modulated symbols. It should be noted that, although certain procedures have parameter Q, the presented procedure may not force that each Tx symbol is based on exactly Q input bits and the transmitter may learn the best way to associate input data to Tx symbols. In addition, each input bit may affect more than one Tx symbol as its effect can propagate through different output streams when passing through the NN blocks. These are two properties that may be used to improve a model.

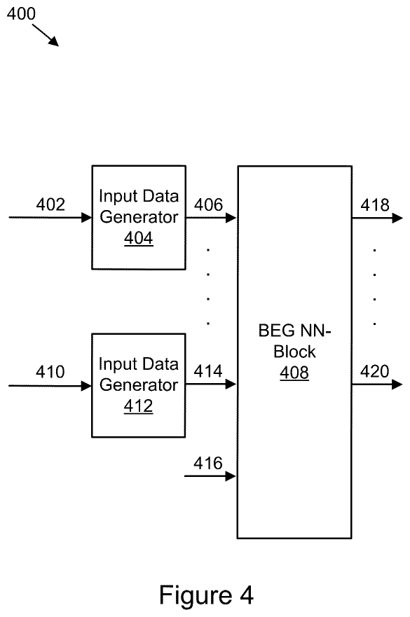

FIG. 4 illustrates another example of a block diagram 400 of blocks that may be in a receiver in accordance with aspects of the present disclosure. Several methods may be used at a receiver side to recover transmitted data. One implementation can be based on the following procedure.

A receiver may first perform OFDM demodulation, e.g. FFT and CP removal and recover a complex valued for each of the RE at each of the N receiver antennas. For each RB, for example, the b-th RB, there may be a maximum of S×K complex numbers associated to the S×K REs, \tilde{y}_{n,b}[ν] for ν={1, 2, . . . , S×K} 402, 410 and n={1, 2, . . . , N}. Note that some of these REs may be nulled out (for example, as a guard bands).

In some implementations, the receiver may be able to perform equalization (based on the knowledge it may have about the channel) and the resulting complex values for each RE may then be the equalized values. Based on a particular implementation, the resulted \tilde{y}_{n,b}[ν] passes through an input data generator 404, 412 block which selects a few, for example J′ of the REs. Further, using the real and imaginary part of the complex number associated to these J′ REs, this block generate the n-th input sequence of size J′×2 denoted by y_{n,b}[ν] for ν={1, 2, . . . , 2×J′} 406, 414 and n={1, 2, . . . , N}. Which REs are selected may be based on an implementation. For example, the Rx may decide to remove null REs or may decide to remove or keep the REs that may be used for transmission of the reference symbols, if there are any.

It should be noted that, in general, J′ may be different than J as it might be better for the BEG NN-block to observe the received symbols on REs which are not carrying the input data directly. For example, if any RE is reserved for RS transmission, it might be useful to feed the received symbols on those REs to the BEG NN-block.

The next block is a bit-estimate-generator NN block (BEG NN-block) 408 that receives all y_{n,b}[ν] as the input and generates soft or hard values associated with each input/encoded/channel-coded bits of all the layers. So the total number of output neurons of the BEG NN-block 408 may be L (number of layers) times Q×J (number of bits we have assumed exist in each layer of data), i.e., Ψ_{l,b}[ν] for ν={1, 2, . . . , Q×J} and l={1, 2, . . . , L}. In some implementations, in addition to y_{n,b}[ν], BEG NN-block 408 may receive some other input information 416 such as current channel SNR, or estimated channel information if available (e.g., channel estimated at the receiver).

In various implementations, Ψ_{l,b}[ν] 418, 420 represents the llr associated with each of the bits of each layer. These llr may be passed through a hard decoder to be converted to bits or may be assumed as soft input to the deinterleave or FEC decoder.

It should be noted that, certain implementations described herein are based on trainable parameters that may be determined during a training phase. These parameters may include: parameters related to SG NN-block or equivalently LSG NN-block for each input layer if the layer wise architecture is used at the transmitter, parameters related to the extension block if there is an extension block in the transmitter and if is implemented based on NN-block, parameters related to the quantizer, for example, the [symbol] codewords of length 2 of a vector quantizer if it has been used in the transmitter, and/or parameters related to BEG NN-block which is located at the receiver.

It may be assumed that the Tx and Rx are trained for 1 RB. In certain networks, the bandwidth and number of OFDM symbols may be larger than one RB. In one example, the NN model may be trained for a bandwidth and number of OFDM symbols larger than one RB. In another example, the transmitter uses the same trained model for each RB separately. This method may be used as there is no need to train different models for different bandwidths and available OFDM symbols. Moreover, it may reduce processing latency for Tx transmission and Rx reception as different RBs can be processed in parallel.

In some examples, symbol-level rate-matching may be used when the number of available REs for data transmission in an RB may be more or less (e.g., due to different number of OFDM symbols) than J REs that the blocks in a transmitter. For example, when the number of available REs for data transmission in an RB is more than J REs, some of the REs at the output of the symbol generator block Γ_{l,b}[j] may be repeated to match the number of available REs for data transmission, e.g., by circular symbol buffer rate matching. In another example, when the number of available REs for data transmission in an RB is less than J REs, some of the REs at the output of the symbol generator block Γ_{l,b}[j] may be punctured.

To determine the correct values for certain models, such models may need to be trained. One method to train the parameters is to feed the transmitter with batches of B samples, where each sample includes randomly generated d_{l,b}[ν] for all layers. For SNR-aware transmitters, one SNR value is also randomly selected for each sample and fed to the network along with the corresponding sample. In some implementations, the SNR value for all samples of each batch is the same and for some other implementation they may be different.

Based on a given input, a transmitter generates OFDM symbols at the output which may include an expansion block and quantizer block based on specific settings. These symbols may then be fed to a channel model which simulates the effect of a channel including fading effect and noise effect. The output of the channel model for each receiver antenna may then be used to generate \tilde{y}_{n,b}[ν]. For SNR-aware settings, the channel model uses the SNR value that has been assigned to each sample. If no SNR has been assigned to each sample, one SNR value is randomly selected for each sample and used for channel modeling. In some implementations, the SNR value for all samples of each batch is the same and for some other implementation they may be different.

Corresponding to each of the B samples in each batch, the receiver may get one sample including \tilde{y}_{n,b}[ν] for each of the Rx antennas. These samples are then fed to the receiver block. Based on some implementations, the SNR value associated to each sample may also be fed to the receiver model. For each input sample, the receiver may generate Ψ_{l,b}[ν] for all layers that may correspond with the randomly generate d_{l,b}[ν] for all layers. Based on the generated data, a loss function may be computed. Parameters of the model may be gradually optimized to minimize the loss function.

In some implementations, selection of a loss function is an implementation choice. In one implementation, the loss function may include certain terms. For example, there may be parts to ensure the similarity of Ψ_{l,b}[ν] and d_{l,b}[ν] for ν={1, 2, . . . , Q×J} and l={1, 2, . . . , L}.

In another implementation, Ψ_{l,b}[ν] can be seen as the llr associated with each of the Q×J bit for l={1, 2, . . . , L}. In such cases, Ψ_{l,b}[ν] may be used as a soft-input of an FEC decoder.

To force the network to generate Ψ_{l,b}[ν] as the llr values, the following may be used as a first part of the loss function:

$$\begin{matrix}{ε}_{l , b} [ v ] = - {d}_{l , b} [ v ] \cdot log ( σ ( {Ψ}_{l , b} [ v ] ) ) - ( 1 - {d}_{l , b} [ v ] ) \cdot log ( 1 - σ ( {Ψ}_{l , b} [ v ] ) ) , \\ {loss}_{1} = \frac{1}{B} {\sum }_{samples} {\sum }_{l , b , v} {ε}_{l , b} [ v ] .\end{matrix}$$

One implementation for determining a vector quantizer parameters may add another function to the loss function. It may be assumed to have j of vector xⱼ∈R² and quantization of them may be performed based on [symbol] vectors size R², i.e, [symbol] ∈R² for q={1, 2, . . . , [symbol] }. A best set of [symbol] may be found. For this, the transmitter may randomly initialize the set of [symbol] . Then for each xⱼ, j={1, 2, . . . , j} determines the closes [symbol] , denoted by

$${𝕩}_{j}^{q} .$$

As both [symbol] and xⱼ are not nixed and may be trained, the loss function may be computed as:

$${loss}_{2} = \frac{1}{j} {\sum }_{j} ( {( {x}_{j} - stopgradient ( {𝕩}_{j}^{q} ) )}^{2} + {( {𝕩}_{j}^{q} - stopgradient ( {x}_{j} ) )}^{2} )$$

In certain implementations, the output of the transmitter is power limited, otherwise during the training process, the transmitter may increase their output power to compensate for any noise or distortion. This constrain may also have different implementations. One implementation may be to add a term to the loss function penalizing the average output power if it exceeds a certain limit. For example, assume that an average power constraint is imposed on j of complex number xⱼ. In such an example, the corresponding loss function may be formulated as the following.

$${loss}_{3} = max ( 0 , \frac{1}{j} {\sum }_{j} {‖ {x}_{j} ‖}^{2} - 1 ) .$$

This function penalizes the designed model parameters if the average power of xⱼ gets larger than 1. It should be noted that the threshold value “1” in the above equation may be substituted by a desired value. It should be noted that as this constraint is on the average power, the number of samples, i.e., j, may be large enough to have a good representation of the average power.

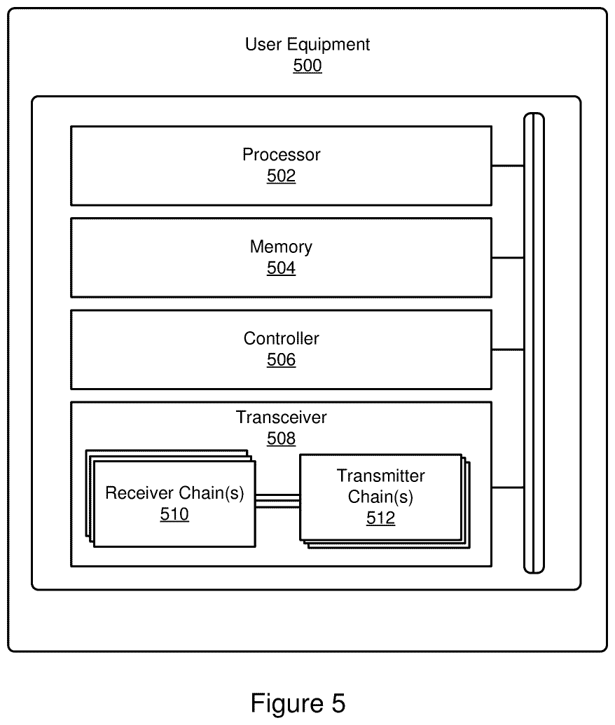

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. For example, the processor 502 coupled with the memory 504 may be configured to cause the UE 500 to perform various actions described herein.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

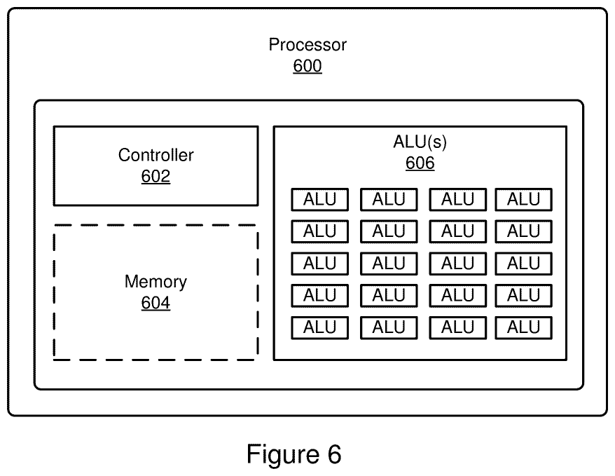

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for performing various operations described herein. For example, the processor 600 may be configured to, capable of, or operable to: receive a plurality of input bits of a codeword or encode a plurality of information bits corresponding to a transport block with a forward error correction code to generate the plurality of input bits of the codeword, wherein a quantity of the plurality of input bits is a multiple of a characteristic parameter of a neural network-based symbol generator; generate a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same; and transmit, to a second node, a mapping of the plurality of symbols based on a transmission scheme. Additionally, or alternatively, the processor 600 may be configured to, capable of, or operable to receive a plurality of symbols associated with a plurality of time-frequency resources for a plurality of receiving antennas; select a subset of the plurality of symbols for each antenna of the plurality of receiving antennas and generating a plurality of input streams for the plurality of receiving antennas based on the selected subset of the plurality of symbols; and generate a plurality of output-data estimations based on the plurality of input streams and a neural network-based bit-estimation-generator.

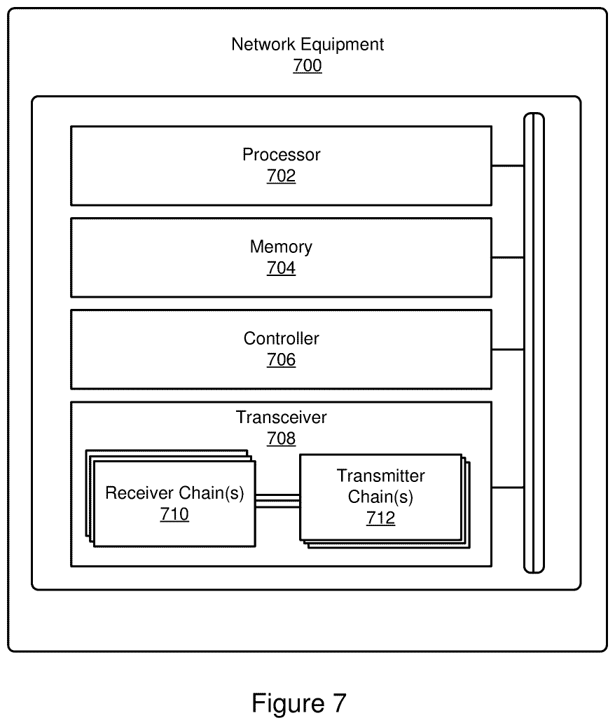

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure. For example, the processor 702 coupled with the memory 704 may be configured to cause the NE 700 (e.g., a first NE) to: receive a plurality of input bits of a codeword or encode a plurality of information bits corresponding to a transport block with a forward error correction code to generate the plurality of input bits of the codeword, wherein a quantity of the plurality of input bits is a multiple of a characteristic parameter of a neural network-based symbol generator; generate a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same; and transmit, to a second node, a mapping of the plurality of symbols based on a transmission scheme. Additionally, or alternatively, the processor 702 coupled with the memory 704 may be configured to cause the NE 700 to receive a plurality of symbols associated with a plurality of time-frequency resources for a plurality of receiving antennas; select a subset of the plurality of symbols for each antenna of the plurality of receiving antennas and generating a plurality of input streams for the plurality of receiving antennas based on the selected subset of the plurality of symbols; and generate a plurality of output-data estimations based on the plurality of input streams and a neural network-based bit-estimation-generator.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

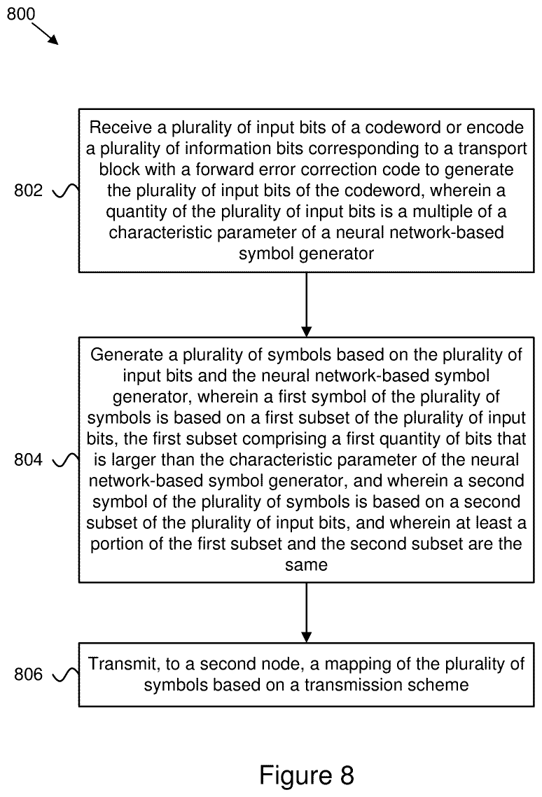

FIG. 8 illustrates a flowchart of a method 800 in accordance with aspects of the present disclosure. The operations of the method 800 may be implemented by a first node (e.g., a UE, a base station) as described herein. In some implementations, the first node may execute a set of instructions to control the function elements of a processor to perform the described functions. It should be noted that the method described herein describes a possible implementation, and that the operations and the steps may be rearranged or otherwise modified and that other implementations are possible.

At 802, the method may include receiving a plurality of input bits of a codeword or encoding a plurality of information bits corresponding to a transport block with a forward error correction code to generate the plurality of input bits of the codeword, wherein a quantity of the plurality of input bits is a multiple of a characteristic parameter of a neural network-based symbol generator. The operations of 802 may be performed in accordance with examples as described herein. In some implementations, aspects of the operations of 802 may be performed by a NE as described with reference to FIG. 7.

At 804, the method may include generating a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same. The operations of 804 may be performed in accordance with examples as described herein. In some implementations, aspects of the operations of 804 may be performed by a NE as described with reference to FIG. 7.

At 806, the method may include transmitting, to a second node, a mapping of the plurality of symbols based on a transmission scheme. The operations of 806 may be performed in accordance with examples as described herein. In some implementations, aspects of the operations of 806 may be performed by a NE as described with reference to FIG. 7.

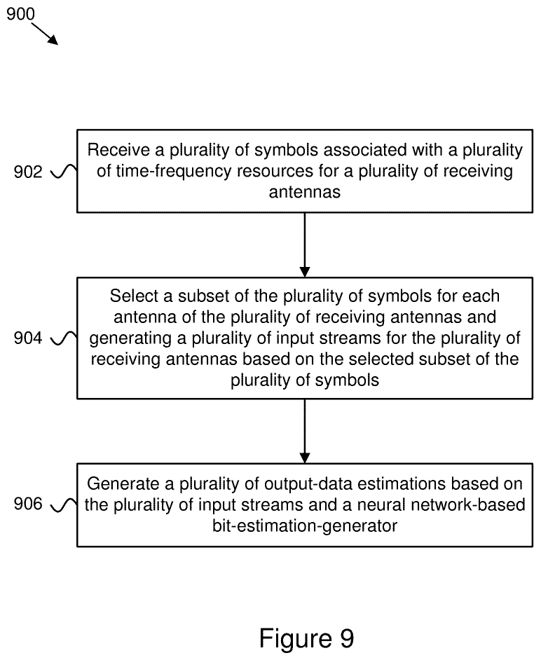

FIG. 9 illustrates a flowchart of another method 900 in accordance with aspects of the present disclosure. The operations of the method 900 may be implemented by a second node (e.g., a UE, a base station) as described herein. In some implementations, the second node may execute a set of instructions to control the function elements of a processor to perform the described functions. It should be noted that the method described herein describes a possible implementation, and that the operations and the steps may be rearranged or otherwise modified and that other implementations are possible.

At 902, the method may include receiving a plurality of symbols associated with a plurality of time-frequency resources for a plurality of receiving antennas. The operations of 902 may be performed in accordance with examples as described herein. In some implementations, aspects of the operations of 902 may be performed by a NE as described with reference to FIG. 7.

At 904, the method may include selecting a subset of the plurality of symbols for each antenna of the plurality of receiving antennas and generating a plurality of input streams for the plurality of receiving antennas based on the selected subset of the plurality of symbols. The operations of 904 may be performed in accordance with examples as described herein. In some implementations, aspects of the operations of 904 may be performed by a NE as described with reference to FIG. 7.

At 906, the method may include generating a plurality of output-data estimations based on the plurality of input streams and a neural network-based bit-estimation-generator. The operations of 906 may be performed in accordance with examples as described herein. In some implementations, aspects of the operations of 906 may be performed by a NE as described with reference to FIG. 7.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node, comprising:
at least one memory; and
at least one processor coupled with the at least one memory and configured to cause the first node to:
receive a plurality of input bits of a codeword or encode a plurality of information bits corresponding to a transport block with a forward error correction code to generate the plurality of input bits of the codeword, wherein a quantity of the plurality of input bits is a multiple of a characteristic parameter of a neural network-based symbol generator;
generate a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same; and
transmit, to a second node, a mapping of the plurality of symbols based on a transmission scheme.

2. The first node of claim 1, wherein the second subset comprises a second quantity of bits that is larger than the characteristic parameter of the neural network-based symbol generator, and wherein the characteristic parameter comprises a bits per symbol characteristic of the neural network-based symbol generator.

3. The first node of claim 1, wherein a third symbol of the plurality of symbols is based on a third subset of the plurality of input bits, and the third subset comprises a third quantity of bits that is smaller than the characteristic parameter of the neural network-based symbol generator, and wherein the characteristic parameter comprises a bits per symbol characteristic of the neural network-based symbol generator.

4. The first node of claim 1, wherein a third symbol of the plurality of symbols is independent of the plurality of input bits.

5. The first node of claim 1, wherein the at least one processor is configured to cause the first node to generate the plurality of symbols based on the plurality of input bits, the neural network-based symbol generator, a channel quality metric, a preferred precoding matrix, a rank of a channel between the first node and the second node, or a combination thereof.

6. The first node of claim 1, wherein the neural network-based symbol generator comprises a set of model parameters having at least a set of neural network weights.

7. The first node of claim 6, wherein at least a portion of the set of neural network weights is associated with a symbol quantizer, and wherein a logarithm base-2 of a cardinality of a set of symbol constellation points of the symbol quantizer is larger than the characteristic parameter of the neural network-based symbol generator.

8. The first node of claim 7, wherein the symbol quantizer is based on a scalar quantizer or a vector quantizer.

9. The first node of claim 6, wherein at least a portion of the set of neural network weights is associated with a precoder, and the neural network-based symbol generator generates the plurality of symbols for a plurality of transmit antenna ports based on the precoder.

10. The first node of claim 9, wherein the codeword is mapped to a plurality of layers, and the neural network-based symbol generator generates the plurality of symbols for a plurality of transmit antenna ports based on the precoder and input bits corresponding to the plurality of layers.

11. The first node of claim 6, wherein the set of model parameters is determined to minimize a loss function, and wherein the loss function at least depends on a negative of a similarity metric showing a correspondence of the plurality of input bits and their corresponding estimation at a receiver and a penalty term based on an average of a power of the plurality of symbols exceeding a threshold.

12. The first node of claim 11, wherein the similarity metric is based on binary cross-entropy between the plurality of input bits and a sigmoid of their corresponding estimation at the receiver.

13. The first node of claim 1, wherein the at least one processor is configured to cause the first node to map the plurality of symbols to a time-frequency-antenna port resource.

14. A processor for wireless communication, comprising:
at least one controller coupled with at least one memory and configured to cause the processor to:
receive a plurality of input bits of a codeword or encode a plurality of information bits corresponding to a transport block with a forward error correction code to generate the plurality of input bits of the codeword, wherein a quantity of the plurality of input bits is a multiple of a characteristic parameter of a neural network-based symbol generator;
generate a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same; and
transmit, to a second node, a mapping of the plurality of symbols based on a transmission scheme.

15. The processor of claim 14, wherein the second subset comprises a second quantity of bits that is larger than the characteristic parameter of the neural network-based symbol generator, and wherein the characteristic parameter comprises a bits per symbol characteristic of the neural network-based symbol generator.

16. The processor of claim 14, wherein a third symbol of the plurality of symbols is based on a third subset of the plurality of input bits, and the third subset comprises a third quantity of bits that is smaller than the characteristic parameter of the neural network-based symbol generator, and wherein the characteristic parameter comprises a bits per symbol characteristic of the neural network-based symbol generator.

17. A method performed by a first node, the method comprising:
receiving a plurality of input bits of a codeword or encoding a plurality of information bits corresponding to a transport block with a forward error correction code to generate the plurality of input bits of the codeword, wherein a quantity of the plurality of input bits is a multiple of a characteristic parameter of a neural network-based symbol generator;
generating a plurality of symbols based on the plurality of input bits and the neural network-based symbol generator, wherein a first symbol of the plurality of symbols is based on a first subset of the plurality of input bits, the first subset comprising a first quantity of bits that is larger than the characteristic parameter of the neural network-based symbol generator, and wherein a second symbol of the plurality of symbols is based on a second subset of the plurality of input bits, and wherein at least a portion of the first subset and the second subset are the same; and
transmitting, to a second node, a mapping of the plurality of symbols based on a transmission scheme.

18. A second node, comprising:
at least one memory; and
at least one processor coupled with the at least one memory and configured to cause the second node to:
receive a plurality of symbols associated with a plurality of time-frequency resources for a plurality of receiving antennas;
select a subset of the plurality of symbols for each antenna of the plurality of receiving antennas and generating a plurality of input streams for the plurality of receiving antennas based on the selected subset of the plurality of symbols; and
generate a plurality of output-data estimations based on the plurality of input streams and a neural network-based bit-estimation-generator.

19. The second node of claim 18, wherein the at least one processor is configured to cause the second node to generate the plurality of output-data estimations based on the plurality of input streams and the neural network-based bit-estimation-generator, and at least one of a channel quality metric, an estimation of a channel, and a location of reference symbols.

20. The second node of claim 18, wherein the at least one processor is configured to cause the second node to decode the plurality of output-data estimations by at least a decoder of a forward error correction to generate a plurality of information bits corresponding to a transport block.
